(19) United States
(12) Patent Application Publication
(10) Pub. No.: US 2008/0264257 A1
(43) Pub. Date: Oct. 30, 2008

(54) METHOD AND APPARATUS FOR ILLUMINATING AND REMOVING AIRBORNE IMPURITIES WITHIN AN ENCLOSED CHAMBER

(75) Inventors: Frank Ventorina Ryder III, Metairie, LA (US); Doug Peter Magyari, Royal Oak, MI (US); Shane Perry Cohen, Potomac, MD (US)

Correspondence Address: Winston & Strawn LLP;Patent Department, 1700 K Street, N.W., Washington, DC, 20006, US

(73) Assignee: Oreck Holdings, LLC, Cheyenne, WY (US)

(21) Appl. No.: 11/739,747

(22) Filed: Apr. 25, 2007

(51) Int. Cl. B01D 50/00; B23P 17/04

(52) U.S. Cl. 95/291; 29/411; 55/385.1; 96/416

(57) ABSTRACT

An enclosed chamber for illuminating and removing airborne impurities includes at least one air cleaner for removing airborne impurities. The enclosed chamber also includes a means for illuminating the airborne impurities. Airborne impurities can be introduced into the enclosed chamber through an aperture in a chamber housing of the enclosed chamber.

### TECHNICAL FIELD

The invention relates to air cleaners, and in particular, to an apparatus that makes impurities in the air visible before an air cleaner removes the impurities.

### BACKGROUND OF THE INVENTION

Due to increasing pollution levels many people have turned to air cleaners as a way to increase the quality of air they breathe, at least within the home or office. Air cleaners are devices that remove impurities from the air. Common types of impurities can include smoke, dust, pollen and other allergens, pet hair and pet dander, airborne mold and bacteria, and volatile organic compounds (VOCs), etc. They are often used by persons suffering from allergies or persons who are sensitive to impurities. They are used by persons in settings where impurities are at higher than normal levels. They are used by persons for medical reasons, such as to avoid infection and/or irritation of the respiratory system. They are used by persons having respiratory problems.

Before purchasing an air cleaner, a customer may want to know how well it performs. For example, a customer may want to know how well impurities are removed from the surrounding environment. A problem exists, however, because many of the impurities are relatively unnoticeable under normal lighting conditions. Therefore, a difficulty exists in evaluating how well a particular air cleaner removes impurities before purchasing. Even if the air cleaner is turned on, the potential customer has no way of determining how well the air cleaner is removing impurities. There exists a need for a way to determine the efficiency of an air cleaner in removing impurities that, under normal lighting conditions, are relatively unnoticeable.

### SUMMARY OF THE INVENTION

An apparatus for illuminating and removing airborne impurities from within an enclosed chamber is provided according to an embodiment of the invention. The apparatus comprises a chamber housing and airborne impurities within the chamber housing. The apparatus is provided with a means for illuminating the airborne impurities and at least one air cleaner coupled to the chamber housing for removal of the airborne impurities.

A method for forming a chamber for illuminating and removing airborne impurities from within an enclosed chamber is provided according to an embodiment of the invention. The method comprises providing a chamber housing and providing airborne impurities within the chamber housing. The method also comprises providing one or more illuminating lamps for illuminating the airborne impurities and at least one air cleaner for removing the airborne impurities.

A method for illuminating and removing airborne impurities from within an enclosed chamber including a chamber housing with a first section and a second section is provided according to an embodiment of the invention. The method comprises introducing airborne impurities into the first section and providing illumination to those airborne impurities. The method also comprises providing an air cleaner for removal of the airborne impurities within the first section of the enclosed chamber.

### BRIEF DESCRIPTION OF THE DRAWINGS

FIG. 1 shows an enclosed chamber for illuminating and removing airborne impurities according to an embodiment of the invention.

FIG. 2 shows the enclosed chamber according to an embodiment of the invention.

FIG. 3 shows the enclosed chamber according to another embodiment of the invention.

### DETAILED DESCRIPTION OF THE INVENTION

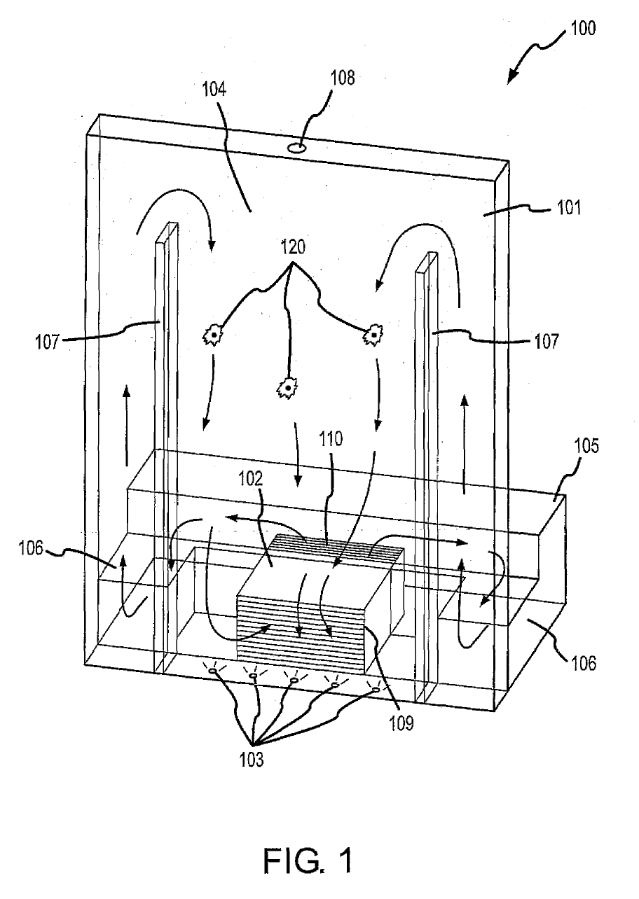

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a chamber 100 according to an embodiment of the invention. The chamber 100 includes a chamber housing 101, at least one air cleaner 102, one or more illuminating lamps 103, and an aperture 108.

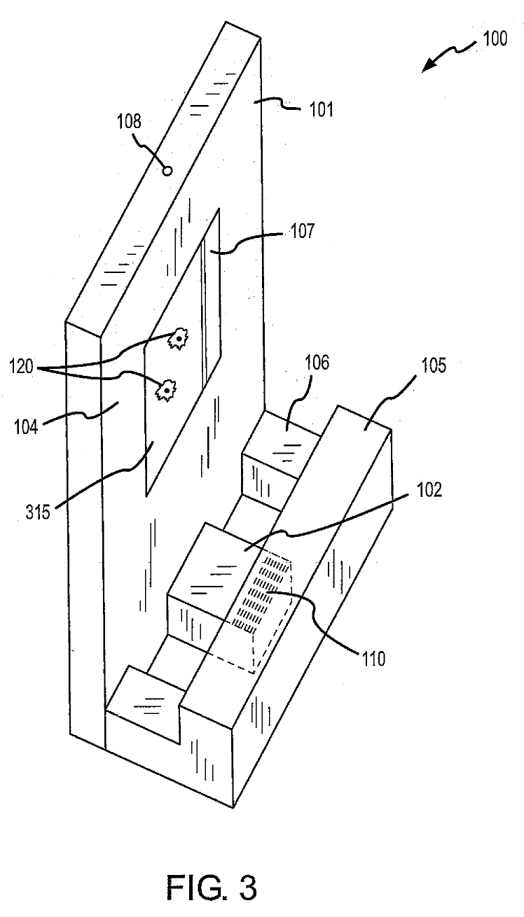

Chamber 100 allows a potential customer an opportunity to monitor how efficient a particular air cleaner is at removing airborne impurities from the surrounding environment. According to an embodiment of the invention, the chamber housing 101 is substantially air-tight. According to an embodiment of the invention, the chamber housing 101 includes a first section 104 and a second section 105. At least the first section 104 can comprise substantially transparent panels. In the embodiment shown in FIG. 1, the whole chamber housing 101 is substantially transparent. Alternatively, the first section 104 could comprise substantially opaque panels. The substantially opaque panels could include a window for monitoring the airborne impurities (see FIG. 3). The first section 104 could also include one or more reflective panels for a better illumination of the airborne impurities.

The first section 104 can be coupled to the second section 105 by at least one air passageway 106. However, the first section 104 and the second section 105 do not need to be coupled by an air passageway 106 and could be separate. In one embodiment, the first section 104 is substantially larger than the second section 105.

The air passageway 106 provides a route for air to flow from the second section 105 to the first section 104. The air passageway 106 can be formed as part of the rest of the chamber housing 101, or alternatively, could be formed separately. In one embodiment, the air passageway 106 is coupled to the first section 104 at a first end and coupled to the second section 105 at a second end. The sections can be sealed together using a silicone casting, for example. Using a silicone casting creates a substantially air-tight seal. It should be understood however, that it is not necessary to use a silicone casting seal. Any type of sealing means can be used.

According to an embodiment of the invention, when the first section 104 and the second section 105 are coupled by an air passageway 106, the first section 104 includes at least one baffle 107. In a preferred embodiment a baffle 107 is provided to correspond to each of the air passageways 106. For example, in FIG. 1, the chamber 100 includes two air passageways 106 and two baffles 107. It should be understood however, that the chamber 100 could include any number of air passageways 106 and baffles 107. The baffles 107 force air to the top of the first section 104 when flowing to the first section 104 from the second section 105 via an air passageway 106.

The first section 104 of the chamber housing 101 can also include an aperture 108. The aperture 108 is provided for introducing airborne impurities, such as airborne impurities 120 into the chamber housing 101. The aperture 108 is shown in the top of the first section 104. However, it should be understood that the aperture 108 could be located anywhere in the first section 104 of the chamber housing 101. According to an embodiment of the invention, the aperture 108 has a door or other closure member (not shown) that can seal the aperture 108.

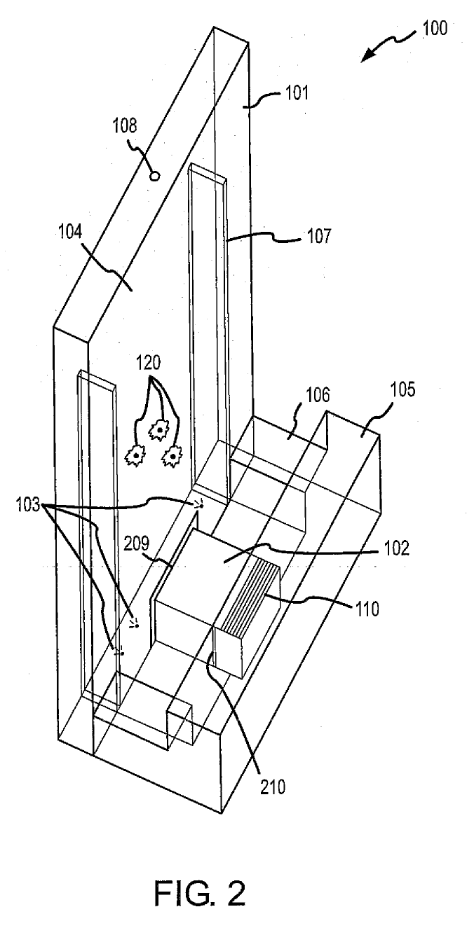

An air cleaner 102 is coupled to the chamber housing 101 according to an embodiment of the invention. The air cleaner 102 is provided to remove airborne impurities that are introduced into the first section 104 of the chamber housing 101. In one embodiment, an air intake 109 of the air cleaner 102 communicates with the first section 104 of the chamber housing 101. The air intake 109, along with a portion of the air cleaner 102, could be inserted into an opening (not shown) in the chamber housing 101, for example. According to one embodiment, if the air intake 109 is inserted into an opening, the insertion creates a substantially air-tight seal between the air intake 109, or a portion of the air cleaner 102, and the opening. In one embodiment, this substantially air-tight seal could be accomplished using a silicone gasket seal 209 (see FIG. 2), for example. However, it should be understood that any type of seal could be used.

An air exhaust 110 of the air cleaner 102 communicates with the second section 105 of the chamber housing 101 according to an embodiment of the invention. According to one embodiment, the air exhaust 110, along with a portion of the air cleaner 102, is inserted into an opening (not shown) in the second section 105 of the chamber housing 101. In one embodiment, this insertion creates a substantially air-tight seal between the air exhaust 110, or a portion of the air cleaner 102, and the opening in the second section 105 of the chamber housing 101. The substantially air-tight seal could be accomplished using a silicone gasket seal 210 (see FIG. 2), for example. However, it should be understood that any type of seal could be used.

Chamber 100 is also provided with a means for illuminating the airborne impurities that are introduced into the first section 104 of the chamber housing 101. According to one embodiment the means for illumination comprises one or more illuminating lamps 103. The illuminating lamps 103 can be located on one or more walls of the first section 104. In one embodiment, the illuminating lamps 103 are located in the bottom wall of the first section 104 and illuminate up and into the first section 104. However, the illuminating lamps 103 could be located anywhere on and/or in the chamber housing 101 that would provide illumination to the airborne impurities within the first section 104 of the chamber housing 101. Alternatively, the illuminating lamps 103 could be remote from the chamber 100 and illuminate into the first section 104 of the chamber housing 101. According to one embodiment of the invention, the illuminating lamps 103 comprise one or more multi-faceted 16/8 inch (MR-16) lamps. In one embodiment five MR-16 lamps are used. The illuminating lamps 103 need not be MR-16 lamps, but could be any lamp that would provide enough light to illuminate small particles that, under normal lighting conditions, cannot easily be seen.

FIG. 3 shows the enclosed chamber 100 according to an embodiment of the invention. In FIG. 3, the chamber housing comprises a substantially opaque material. In this embodiment, the first section 104 is provided with a window, or substantially transparent portion 315, to monitor the efficiency of the air cleaner 102. The transparent portion 315 provides a way to view the airborne impurities when the illuminating lamps 103 are turned on. The transparent portion 315 can also be used in combination with a video or recording device. In the view shown in FIG. 3, a portion of one of the baffles 107 can be seen through the transparent portion 315, along with airborne impurities 120.

The first section 104 of the chamber housing 101 can alternatively comprise a reflective material deposited on the interior of the panels, according to an embodiment of the invention. The reflective material could be a paint or some other coating or film, for example. The reflective material can be provided for a better illumination of the airborne impurities within the chamber housing 101.

Chamber 100 can be used to demonstrate the efficiency of an air cleaner 102 in removing airborne impurities from the surrounding air. According to one embodiment of the invention, airborne impurities are introduced into the first section 104 of the chamber housing 101 through the aperture 108. In a preferred embodiment, the airborne impurities comprise mica particulates. Mica is preferred because of its reflective qualities. Mica also provides for a certain amount of suspension in the air so the particulates do not fall too quickly. It should be understood however, that mica does not need to be used and any airborne impurity capable of being seen upon substantially bright illumination can be used. Additionally, the airborne impurities can comprise fluorescent dirt. In this situation, ultra-violet lights, black lights, or any other special lighting could be used to illuminate the airborne impurity. If the airborne impurity is in the gaseous state, special illuminating lighting capable of illuminating the airborne impurity may be used. It should be understood that the specific airborne impurity and/or lighting should not limit the scope of the invention.

Once the airborne impurities are introduced, the illuminating lamps 103 provide a substantially intense illumination onto the airborne impurities. In one embodiment, the environment surrounding the chamber 100 is provided with a substantially less amount of light than provided inside of the first section 104 of the chamber housing 101 by the illuminating lamps 103. This provides for a better illumination of the airborne impurities within the first section 104 of the chamber housing 101. It should be understood however, that the surrounding environment does not need to be darker than the environment inside of the first section 104.

The air cleaner 102 is provided to remove the airborne impurities that are introduced into the first section 104 of the chamber housing 101. The air cleaner 102 provides suction at the air intake 109. When the air intake 109 communicates with the first section 104 of the chamber housing 101, the air within the first section 104 (along with the airborne impurities) flows into the air cleaner 102. According to one embodiment, the air cleaner 102 substantially removes the airborne impurities from the air within the first section 104 and exhausts air substantially free from airborne impurities through the air exhaust 110.

According to one embodiment, the air cleaner 102 uses an electrostatic precipitator cell to remove airborne impurities. It should be understood however, that any type of air cleaner could be used and it is not necessary that the air cleaner use an electrostatic precipitator cell.

According to one embodiment, the air exhaust 110 communicates with the second section 105. In this embodiment, the air exits the air cleaner 102 through the air exhaust 110 and into the second section 105. The air then flows into at least one air passageway 106. The baffles 107 are included in the first section 104 to force the air returning from the second section 105 to flow to the top of the first section 104 before accessing the air intake 109 of the air cleaner 102. This provides for a faster and more efficient removal of the airborne impurities within the first section 104. It should be understood that the baffles 107 are not required, but do provide for a greater efficiency.

As the air within the chamber housing 101 circulates through the first section 104, the air cleaner 102, the second section 105, the air passageway 106, and above the baffles 107, the amount of airborne impurities in the air is decreased with each circulation. Because the illuminating lamps 103 provide illumination to the airborne impurities within the first section 104, the chamber 100 provides for a way to visually monitor the efficiency of the air cleaner 102 in removing the airborne impurities.

The detailed descriptions of the above embodiments have described the enclosed chamber as consisting of a first section 104 and a second section 105. It should be understood however, that the invention does not need to include two sections and the air cleaner could be coupled to only one section. The air cleaner 102 has also been described as having the air intake 109 coupled to the first section 104 and the air exhaust 110 coupled to the second section 105. It should be understood however, that these could be reversed. Also, the second section 105 could be substantially larger than the first section 104.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other air cleaners and chambers, and not just to the embodiments described above and shown in the accompanying figures. Accordingly, the scope of the invention should be determined from the following claims.

We claim:

1. An apparatus for illuminating and removing airborne impurities from within an enclosed chamber, comprising:
a chamber housing;
airborne impurities within the chamber housing;
a means for illuminating the airborne impurities; and
at least one air cleaner coupled to the chamber housing for removal of the airborne impurities.

2. The apparatus of claim 1, wherein the chamber housing is substantially airtight.

3. The apparatus of claim 1, wherein the chamber housing is substantially transparent.

4. The apparatus of claim 1, wherein the chamber housing includes a substantially transparent portion.

5. The apparatus of claim 1, wherein the enclosed chamber has a first section and a second section, wherein the first section is coupled to the second section by at least one air passageway.

6. The apparatus of claim 5, wherein the first section is substantially larger than the second section.

7. The apparatus of claim 5, wherein the first section contains an aperture for introducing the airborne impurities.

8. The apparatus of claim 5, wherein the first section contains a baffle corresponding to the at least one air passageway.

9. The apparatus of claim 5, wherein an air intake of the at least one air cleaner communicates with the first section and an air exhaust of the at least one air cleaner communicates with the second section.

10. The apparatus of claim 1, wherein the airborne impurities comprise reflective particulates.

11. The apparatus of claim 10, wherein the reflective particulates comprise mica.

12. The apparatus of claim 1, wherein the airborne impurities comprise fluorescent dirt.

13. The apparatus of claim 1, wherein the means for illuminating the airborne impurities comprises one or more illuminating lamps located on at least one wall of the chamber housing.

14. The apparatus of claim 13, wherein the one or more illuminating lamps comprises one or more MR-16 lamps.

15. The apparatus of claim 13, wherein the one or more illuminating lamps comprises one or more Ultra-violet lamps.

16. The apparatus of claim 13, wherein the one or more illuminating lamps comprises one or more black lights.

17. A method for forming an enclosed chamber for illuminating and removing airborne impurities from within the enclosed chamber, comprising:
providing a chamber housing;
providing airborne impurities within the chamber housing;
providing one or more illuminating lamps for illuminating the airborne impurities; and
coupling at least one air cleaner to the chamber housing for removing the airborne impurities.

18. The method of claim 17, wherein the enclosed chamber is substantially airtight.

19. The method of claim 17, wherein the chamber housing is substantially transparent.

20. The method of claim 17, wherein the chamber housing includes a substantially transparent portion.

21. The method of claim 17, further providing the enclosed chamber with a first section and a second section, and coupling the first section to the second section by at least one air passageway.

22. The method of claim 21, wherein the first section is substantially larger than the second section.

23. The method of claim 21, further providing an aperture in the chamber housing of the first section for introducing the airborne impurities.

24. The method of claim 21, further providing the first section with a baffle for each air passageway that is provided, wherein each baffle provides a space near the top of the first section of the enclosed chamber.

25. The method of claim 21, further providing the air cleaner with an air intake, wherein the air intake communicates with the first section of the enclosed chamber and providing the air cleaner with an air exhaust, wherein the air exhaust communicates with the second section of the enclosed chamber.

26. The method of claim 17, wherein providing the airborne impurities comprises providing reflective particulates.

27. The method of claim 26, wherein the reflective particulates comprise mica.

28. The method of claim 17, wherein providing the airborne impurities comprises providing fluorescent dirt.

29. The method of claim 17, further comprising positioning the one or more illuminating lamps on at least one wall of the chamber housing.

30. The method of claim 29, further comprising positioning the one or more illuminating lamps in the bottom wall of the first section, wherein the illuminating lamps illuminate up and into the first section.

31. The method of claim 29, wherein the one or more illuminating lamps comprises one or more MR16 lamps.

32. The method of claim 29, wherein the one or more illuminating lamps comprises one or more ultra-violet lamps.

33. The method of claim 29, wherein the one or more illuminating lamps comprises one or more black lights.

34. A method for illuminating and removing airborne impurities from within an enclosed chamber including a chamber housing with a first section and a second section, comprising:
introducing airborne impurities into the first section of the enclosed chamber;
providing illumination to the airborne impurities in the first section of the enclosed chamber; and
providing at least one air cleaner for removal of the airborne impurities within the first section of the enclosed chamber.

35. The method of claim 34, wherein introducing the airborne impurities comprises introducing the airborne impurities into the first section through an aperture in the first section.

36. The method of claim 34, wherein introducing airborne impurities into the first section of the enclosed chamber comprises introducing mica particles into the first section of the chamber housing.

37. The method of claim 34, wherein introducing airborne impurities into the first section of the enclosed chamber comprises introducing fluorescent dirt into the first section of the chamber housing.

38. The method of claim 34, wherein providing illumination to the airborne impurities comprises providing one or more illuminating lamps located on at least one side of the first section of the chamber housing.

39. The method of claim 38, further providing positioning the one or more illuminating lamps in the bottom of the first section, wherein the illuminating lamps illuminate up and into the first section.

40. The method of claim 38, wherein the one or more illuminating lamps comprises one or more MR-16 lamps.

41. The method of claim 38, wherein the one or more illuminating lamps comprises one or more ultra-violet lamps.

42. The method of claim 38, wherein the one or more illuminating lamps comprises one or more black lights.

43. The method of claim 34, wherein providing at least one air cleaner for removal of the airborne impurities within the first section of the enclosed chamber comprises providing an air intake, wherein the air intake communicates with the first section and providing an air exhaust, wherein the air exhaust communicates with the second section of the enclosed chamber.

44. The method of claim 34, further comprising coupling the first section to the second section with at least one air passageway.

45. The method of claim 44, wherein air containing airborne impurities enters the air cleaner through the air intake which communicates with the first section and air substantially free from airborne impurities exits the air cleaner through the air exhaust which communicates with the second section and returns to the first section through the at least one air passageway.

46. The method of claim 45, further providing the first section with at least one baffle, wherein air returning to the first section through the at least one air passageway must flow to the top of the at least one baffle upon exiting the at least one air passageway.
